(19) United States
(12) Patent Application Publication
(10) Pub. No.: US 2014/0324817 A1
(43) Pub. Date: Oct. 30, 2014

(54) PREPROCESSING OF CLIENT CONTENT IN SEARCH INFRASTRUCTURE

(71) Applicant: BROADCOM CORPORATION, IRVINE, CA (US)

(72) Inventors: Wael William Diab, San Francisco, CA (US); Yasantha Nirmal Rajakarunanayake, San Ramon, CA (US); James Duane Bennett, Hroznetin (CZ)

(73) Assignee: BROADCOM CORPORATION, IRVINE, CA (US)

(21) Appl. No.: 13/902,744

(22) Filed: May 24, 2013

Related U.S. Application Data
(60) Provisional application No. 61/816,923, filed on Apr. 29, 2013.

(51) Int. Cl. G06F 17/30

(52) U.S. Cl. CPC G06F 17/30864
USPC 707/709; 707/736

(57) ABSTRACT

A system and method is provided to distribute preprocessing of client device content. The client device performs preprocessing or alternatively transfers search accessible content to remote systems for preprocessing such as search system infrastructure, set-top boxes, other client devices, etc. Client device content is preprocessed so as to provide, for example, a preview of images available by providing thumbnails of the images, small excerpts of text or a video preview. Offloading of client device content preprocessing duties reduces web server operational requirements and subsequent power needs. Additionally, preprocessing of searchable content can be distributed across multiple content hosts and search infrastructure elements.

### CROSS REFERENCE TO RELATED APPLICATIONS

The present U.S. Utility patent application claims priority pursuant to 35 U.S.C. §119(e) to U.S. Provisional Patent Application Ser. No. 61/816,923, entitled “Preprocessing of Client Content in Search Infrastructure,” filed Apr. 29, 2013, pending, which is hereby incorporated herein by reference in its entirety and made part of the present U.S. Utility patent application for all purposes.

### BACKGROUND

1. Technical Field

The present disclosure described herein relates generally to internet searching infrastructures and more particularly to distributed preprocessing of client content.

2. Description of Related Art

Typical search engine (Web or Social Network based) functionality involves retrieving content (text, image, code, media, etc.) in various formats. Before being able to search (e.g., image and text) a variety of prep work takes place. Web hosting servers are crawled by search infrastructures that gather web page data and associated content. Such data and content are in various formats and require indexing and transformations to support common search algorithms. Underlying central processing demands are enormous. Such efforts are handled by huge, power hungry data centers. Fraud and outdating associated with preprocessed uploads into the search infrastructure may cause additional problems. In addition, various search infrastructures end up hosting the same content and performing pre-output processing thereon.

### BRIEF DESCRIPTION OF THE DRAWINGS

FIG. 1 is a system diagram illustrating a communications environment embodiment in accordance with the present disclosure;

FIG. 2 is an internet search infrastructure diagram illustrating one embodiment in accordance with the present disclosure;

FIG. 3 is a search infrastructure diagram illustrating one embodiment in accordance with the present disclosure;

FIG. 4 illustrates a client device flow diagram showing one embodiment in accordance with the present disclosure;

FIG. 5 illustrates a client device flow diagram showing another embodiment in accordance with the present disclosure;

FIG. 6 illustrates a search infrastructure flow diagram showing one embodiment in accordance with the present disclosure; and

FIG. 7 illustrates a search infrastructure diagram showing one embodiment in accordance with the present disclosure.

### DETAILED DESCRIPTION

In one or more embodiments of the technology described herein, a system and method is provided to distribute preprocessing of client content. In one embodiment, the client performs preprocessing instead of conventional search infrastructure or upload servers.

Whether or not the search infrastructure involves uploading client content for hosting (or caching), preprocessing of such content is needed to produce search data to be added to various search databases within the search infrastructure. For example, reverse indexing data is extracted from text content portions, hyperlinks for others, image characteristics for others, and so on. Preprocessing includes, in one or more embodiments, classification by type, category, and/or function (e.g., video, social media, paid content, etc.). The content is traversed and allocated to similar buckets. Having each client device preprocess its own content offloads the demands on the search infrastructure data centers and in one or more embodiments reduces server farm power requirements (such as allowing rotating power down of servers when not fully used). The actual content may be uploaded thereafter in one or more prepped formats, or it may be maintained locally within the client device.

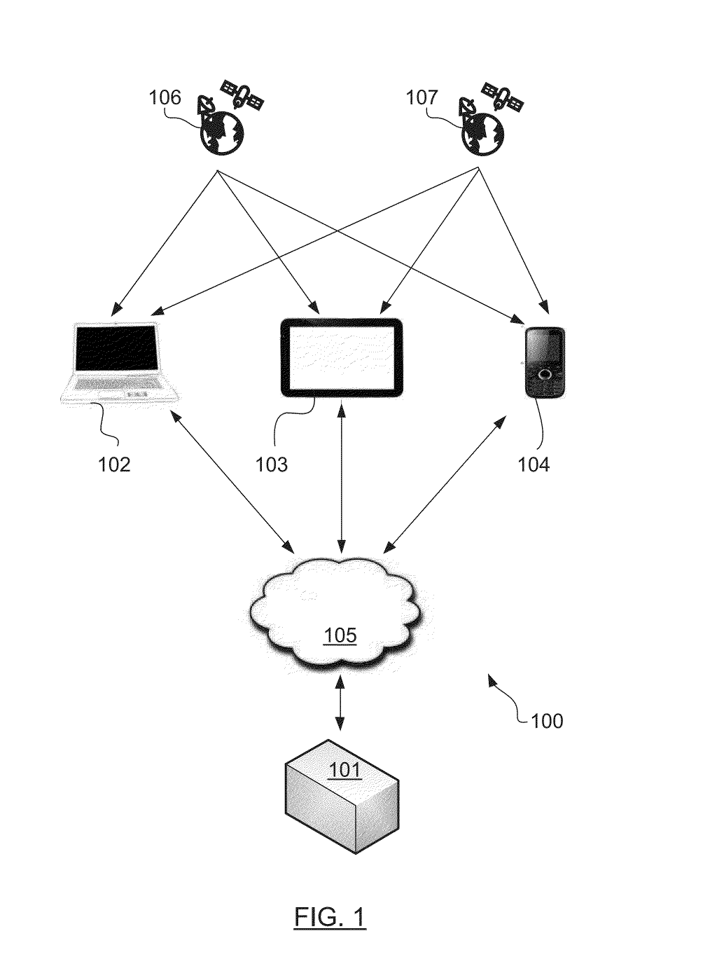

FIG. 1 is a system diagram illustrating an embodiment of a communications environment in accordance with the present disclosure. System 100 includes search system 101 connected to a plurality of mobile communication devices, for example, laptop 102, tablet 103 and smartphone 104, connected via network 105 and in geographically distinct locations. Network 105 may include any known or future communications network, structure and/or standard such as, but not limited to, 3G (Third Generation), 4G (Fourth Generation), LTE (Long-term Evolution), GSM (Global System for Mobile Communications), Wi-Fi, WiMax, WLAN (wireless area network), a WAN (wide area network), a LAN (local area network) and MIMO (Multiple Input Multiple Outputs).

In one embodiment, laptop 102 is used to originate content (e.g., images, video, audio, programming source code, text, database data, etc. in any one of a plurality of file format types). Offloading search system's 101 support responsibilities, laptop 102, in one or more embodiments, preprocesses its originated content to generate at least one search format output that can be uploaded and consumed by search system 101 into its underlying search database infrastructure. After receiving and integrating such search format output, search system 101 receives a search input from tablet 103 that targets the content currently stored on laptop 102. Search system 101 uses the search input in searching database data to identify such content in search results. Thereafter, tablet 103 may interact via the search results and laptop 102 to gain access to the stored content. Instead of, or in addition to, local storage for future search servicing, the originated content itself may be uploaded (along with the preprocessed search format output) for storage within search system 101 to support content delivery from search system 101 to tablet 103 based on search result interaction. Laptop 102 may also further supplement such upload with status information, payment requirements, searcher restrictions, DRM (digital rights management) requirements, loading information, hosting characteristics, scheduling information, etc.

In one or more embodiments, the mobile communication devices are in communication with GPS satellites 106 and 107, and/or terrestrial based location providing services to provide the mobile communication devices with location information. In alternative embodiments, location information for the mobile communication devices is obtained using other information such as media access control (MAC) address, internet protocol (IP) address, or equivalents known or future.

While mobile communication devices 102 to 104 illustrated as laptop 102, tablet 103 and smartphone 104, they are interchangeable with any mobile communications device such as: a cellular telephone, a local area network device, personal area network device or other wireless network device, a personal digital assistant, personal computer, laptop computer, wearable computers, tablet computers or other devices that perform one or more functions that include communication of voice and/or data via a wireline connection and/or the wireless communication path. In yet other embodiments, mobile communication devices 102 to 104 are an access point, base station or other network access device that is coupled to network 105 such as the Internet or other wide area network, either public or private, via a wireline or wireless connection.

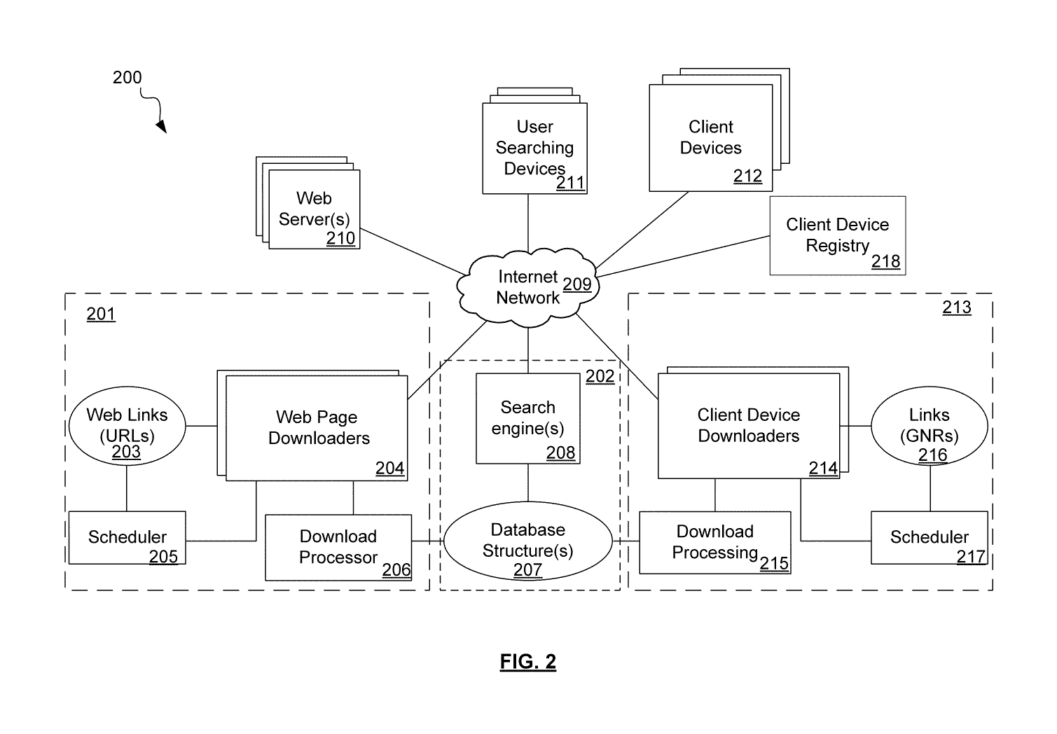

FIG. 2 is an internet search infrastructure diagram illustrating one embodiment in accordance with the present disclosure. Internet search infrastructure 200 includes search system infrastructure components web crawler 201, client device crawler 213 and search engine infrastructure 202. Web crawler 201 includes one or more processing modules 203-206 which systematically browse the World Wide Web (WWW), typically for the purpose of building a database of web based content. Web crawler 201 uses a list of web links (pointers) supplied by link module 203 such as uniform resource locators (URLs) to visit. The URLs are called seeds as they start a process of content discovery and typically are provided by domain registrations. As the crawler visits these URLs, one or more web page downloader module(s) 204 parse the URLs to identify unique hyperlinks in the page, which point to web server 210 to stored content. URLs are typically recursively visited according to a set of policies, which detect structure and content. As links are traversed, web pages and specific content are downloaded by web page downloader module(s) 204 as per a schedule dictated by scheduler module 205.

Web page downloader module(s) 204 will interact with each web server to manage content related uploads into the search infrastructure 200. A first group of web servers 210 will act in conventional ways by providing content in native formats (html, xml, jpg, mp3, pdf, etc.) without preprocessing of the content. In addition to providing such content uploads, a second group of web servers 210 will also upload associated preprocessing output, i.e., at least one search format output that is more easily consumed into the search database structure 207 of the search engine infrastructure 202. A third group of web servers will provide such preprocessing output uploads, but without content uploading.

In one embodiment, web page downloader module(s) 204 further include preprocessing of webpages. Preprocessing, typically performed by web server(s) 210, includes extracting, in one embodiment, non-text information about images. This information includes, for example, whether the image is black and white, a sketch, drawing file, full color, a photograph, clip art, facial recognition, age/sex id (i.e., adult, child, senior, male, female, etc.). In addition, in one embodiment, access information is extracted such as public, private, sharing lists, grouping, download and distribution rights, security, or access based on income, gender, age, location, citizenship, relationships, membership, etc.

Download processor module 206 reverse indexes a selected web page to encode web page words (e.g., frequency) while noting a location on the associated page (offset) so that content can be recovered (extracted) at a later time. The indexed data is stored in memory of database structure 207 (search database) where it is stored for later access by search engine(s) 208. In addition to web page words, all Multipurpose Internet Mail Extensions (MIME) (file types and formats) can be preprocessed by dedicated processing elements so as to produce something that can easily be integrated into a search database structure to support searching. Other examples include, but are not limited to, .mp3 files being analyzed to identify pop, jazz, or other music type, versus child, animal, adult female voices, etc. Image analysis and categorization such as line drawing, sketch, black and white, painting scan, watercolor, content identity: face, architecture, landscape, group of humans, object identification, face identification (actual name determination), etc.; program code language, underlying functions, operating environments, programmers, updates, version, copyright, etc., as determined from the code file and file format; text within any content file format (such as reverse indexing word and pdf files or via OCR's (optical character recognition) associated with scanned text or image text. Common database needs to (reverse) index parameters and text into a common structured format, while breaking down the obligation to search and process across each MIME types repeatedly. While such preprocessing could take place centrally, offloading at least a portion of the preprocessing duties to either clients or both of the web servers reduces workload requirements for any of the devices.

In one or more embodiments, database structure 207 includes indexes of unique words with associated index pointers (URLs) and web page position information. Unique words are hashed using a hash table. A hash table (also hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance using frequency ranking. For example, in the phrase “the cat”, the word “the” is not important and the word “cat” is important. Rare words are often given highest importance along with strings of words and rare strings of words.

Internet Network 209 is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The internet network is used to interconnect the various elements of system 200 and is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Internet Network 209 interconnects web servers 210, user searching devices 211 and client devices 212, to the search system infrastructure (201, 202 and 213) which use the indexed data to match a user input search string from user search device 211 (e.g., smartphone, tablet, laptop, desktop or other known or future user devices with communications capabilities).

The internet search infrastructure of FIG. 2 is, in one or more embodiments described herein, also in communication with one or more GPS satellites and/or terrestrial geographic location systems (FIG. 1 elements 106 and 107) that provide the one or more communication devices with location information. In alternative embodiments, location information for one or more communication devices is obtained using other information such as a media access control (MAC) address, an internet protocol (IP) address, or the like.

In one or embodiments of the technology described herein, internet search infrastructure 200 includes client device generated and/or hosted data. Client device generated data includes creation of content by users of client devices 212 (e.g., mobile communication devices 102 to 104). Once new content is created by the user of client device 212, the data is stored locally (e.g., in memory on the client device 212 with an associated pointer to the content) or remotely (e.g., within the search system infrastructure and/or in the cloud including, for example, third party servers with a modified pointer). Created client device content includes, in one embodiment, downloaded content and/or aggregated content on the client device.

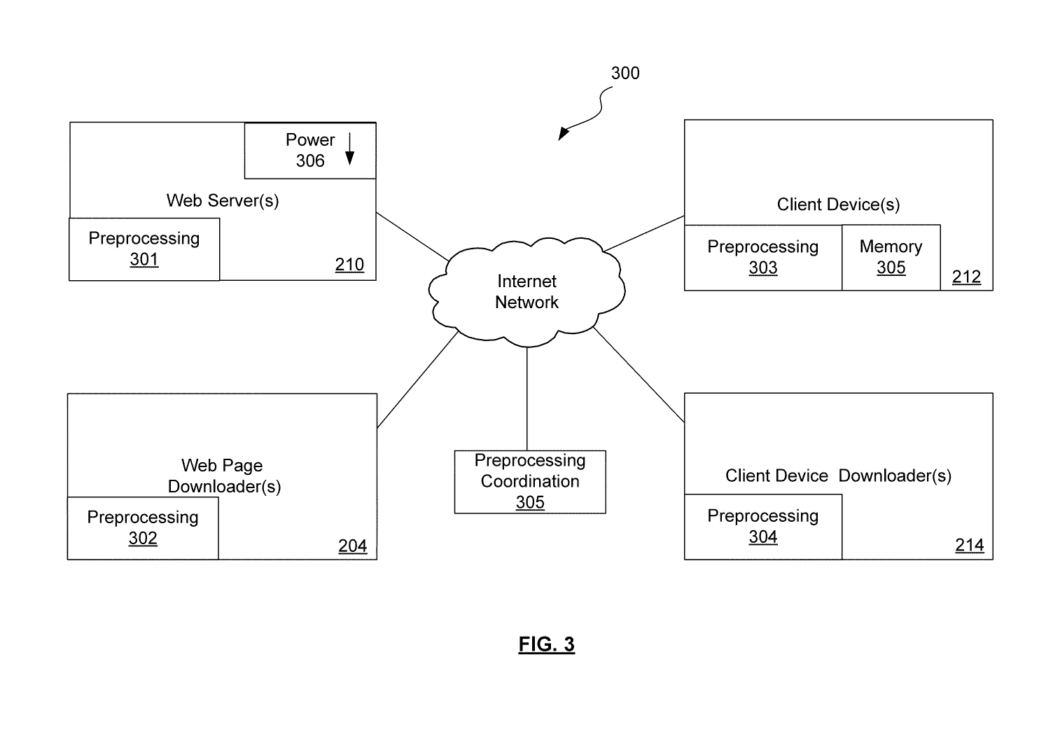

Content hosted by client device 212 (client device content) is supported within the search system infrastructure by client device content crawler 213 which mirrors the web crawling elements 201. While shown as separate crawlers, web and client device crawling functions can, in one embodiment, be combined into a single crawler system providing crawling for both web and client hosted content. Client device content crawling system 213 accesses and parses content(data) stored in memory (shown in FIG. 3, element 305) on one or more client devices 212 in much the same way a traditional web crawler would crawl a web page located on a web server. The client device content crawler 213 includes, but is not limited to, one or more client device downloader modules 214 which access and process (e.g., parse) the content hosted by the client device in a similar fashion to web pages for downloader module 204. Client device downloader module(s) 214 can, in one or more embodiments, receive a link/pointer (such as a global network route) which is a unique path to client device content and/or associated content) from link module 216, download the content itself directly from the client device or a download a copy of the client device hosted content from a client device designated storage location external to the client device. In addition, access data (e.g., client device identification, client type, and client status) is made available to the downloader modules to provide access to the content/associated content (e.g., preprocessed content). In one embodiment, the client device provides the pointer and access data to a client device registry 218, for example a registry maintained in memory within a cloud based service which is accessible by the search system infrastructure (downloader module). The client device content crawling system 213 further includes scheduler module 217 to schedule the crawling of the client device created/stored content and download processor module 215 to reverse index the client device hosted content and distribute to database structure 207 which is accessible by search engine(s) 208 and user searching devices 211.

User searching devices 211 include, but are not limited to: mobile phones; smartphones; tablets; laptops; desktops; or other known or future user computing devices with communications capabilities. In one or more embodiments disclosed herein, mobile communication devices are the recipients of the preprocessed, indexed and stored search system infrastructure output. These mobile communication devices are, in one or more embodiments, a mobile phone such as a cellular telephone, smartphone, a local area network device, a personal area network device or other wireless network device, a personal digital assistant, a personal computer, a laptop computer, wearable computers (e.g., heads-up display (HUD) glasses), tablet computers or other devices that perform one or more functions that include communication of voice and/or data via a wireline connection and/or the wireless communication path. Additionally, in one or more embodiments, mobile communication devices are an access point, base station or other network access device that is coupled to a network such as the Internet or other wide area network, either public or private, via a wireline/wireless connection. Please note, while shown as separate devices for functional clarity, user searching devices can also be client devices and vice-versa (e.g., using smartphones or tablets).

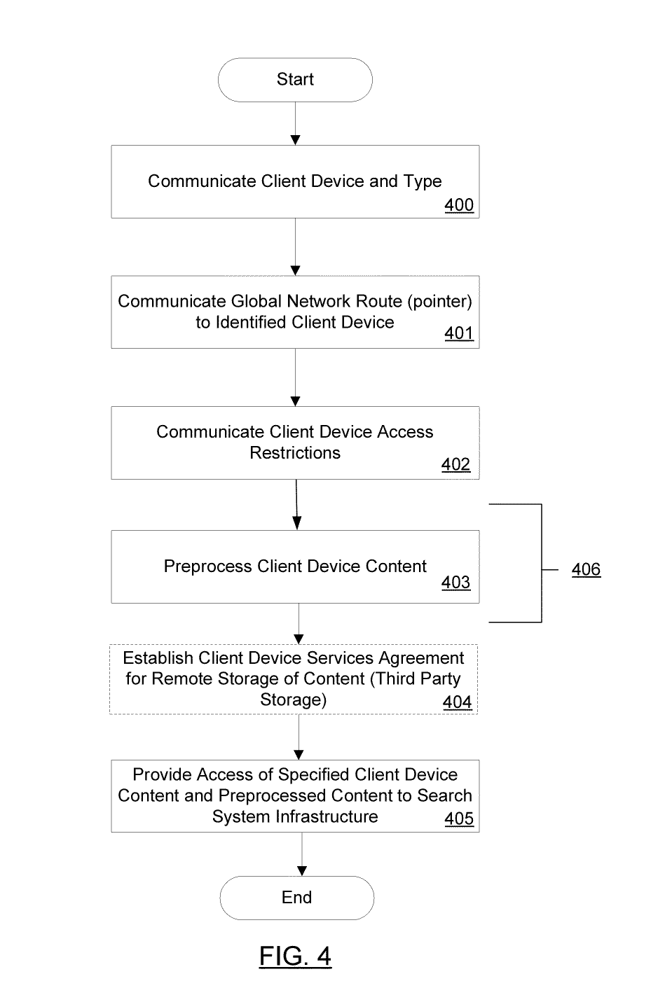

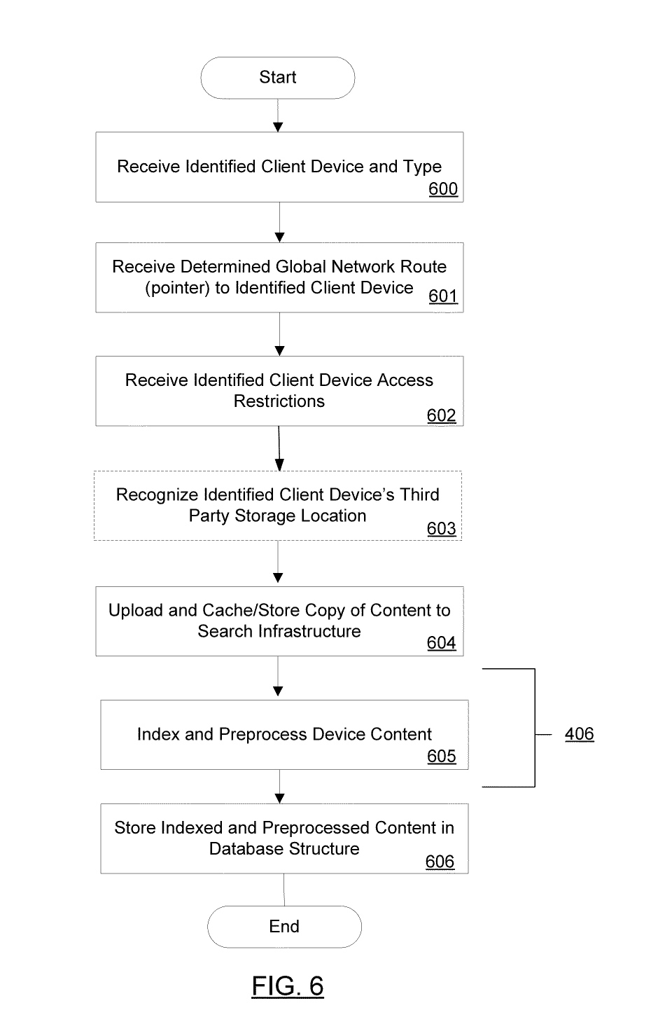

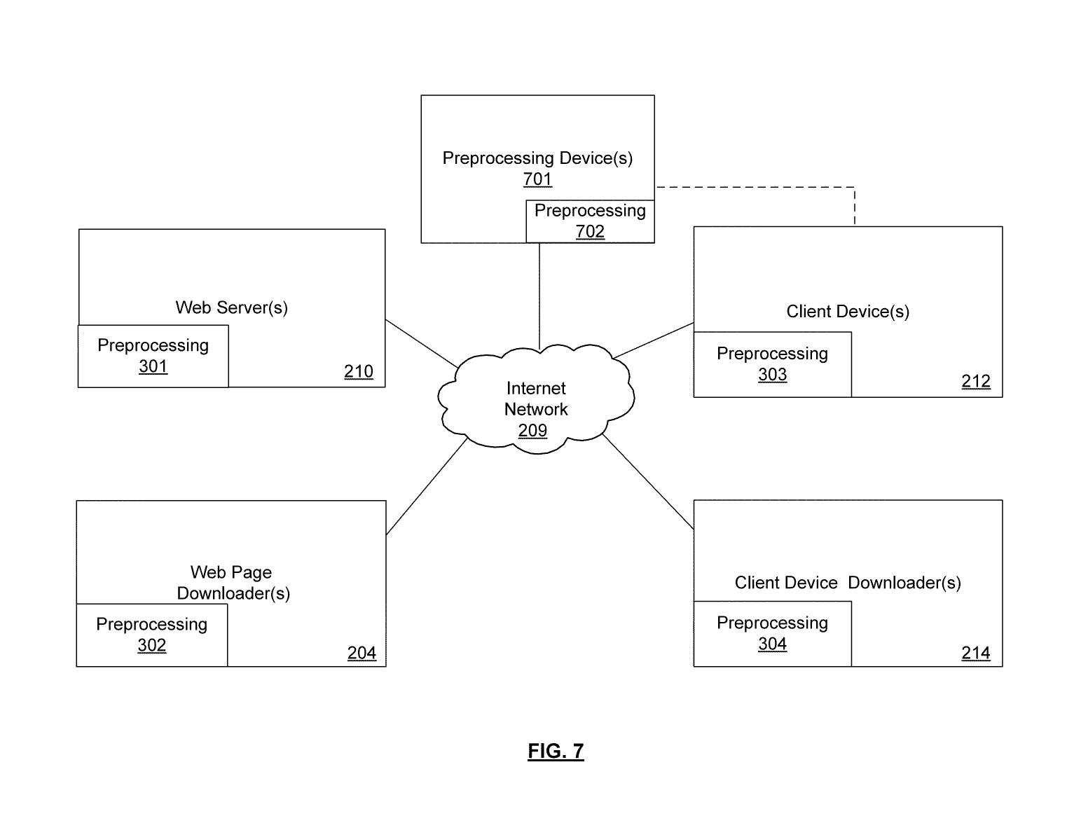

FIG. 3 is a search infrastructure diagram illustrating one embodiment in accordance with the present disclosure. As shown, FIG. 3 illustrates one embodiment of a search infrastructure including one or more content hosting elements. For purposes of illustration, system 300 includes additional detail and functionality of FIG. 2 web server(s) 210, web page downloader module(s) 204, client device(s) 212, and client device downloader module(s) 214. In one or more embodiments of the technology described herein, preprocessing of content is distributed over multiple content hosting elements and/or search infrastructure. In one embodiment, client content is preprocessed in preprocessing module 303 located within client devices (hosting or not hosting) as further described hereafter with respect to FIG. 4. In one embodiment, client device hosted content is preprocessed in preprocessing module 304 located within search system infrastructure (hosted or not hosted) as further described hereafter with respect to FIG. 6. In one embodiment, client device hosted content is preprocessed in preprocessing module 702 located within preprocessing device module 701 (hosted or not hosted) as further described hereafter with respect to FIG. 7.

In one embodiment, preprocessing functionality is distributed between preprocessing module 301 performed at the web server(s) and preprocessing module 303 performed at client devices. In one additional embodiment, preprocessing functionality is distributed between preprocessing module 301 performed at the web server(s), preprocessing module 303 performed at the client device, and preprocessing modules (302 and 304) performed at one or both of the web and client device crawlers. For example, preprocessing can be performed in whole or in part on a client/web server and centrally within the search infrastructure. This can be dynamic for load balancing on a client, for example, that is busy processing but with available, low cost bandwidth and can include an associated preprocessing fee assessment. In yet another embodiment, client devices and search infrastructure services coordinate or assign preprocessing duties based on processing load demands and/or power reduction objectives through preprocessing coordination module 305. For example, preprocessing on the client device/web server might be required by search infrastructure due to current loading, again dynamic. Such allocations can also include split arrangements with client device/web-server doing part and search infrastructure doing the rest. The actual content may be uploaded thereafter in one or more prepped formats, or it may be maintained locally within memory on the client device or as a copy on memory within third party storage devices (servers).

Whether or not the search infrastructure involves uploading and storing client content for hosting (or caching), preprocessing of such content is needed to produce search data to be added to various search databases within the search infrastructure. For example, reverse indexing data is extracted from text content portions, hyperlinks for others, image characteristics for others, and so on. Having each client device preprocess its own content offloads the demands on the search infrastructure data centers and reduces server farm power requirements 306 (such as allowing rotating power down of servers when they are not fully used).

The technology described herein need not be restricted to a specific search infrastructure, but rather may be applied to current search infrastructures and future infrastructures where uploading occurs. More specifically, in one embodiment, client devices and search infrastructure services coordinate or assign preprocessing duties. Client device preprocessing of at least a portion of client content will reduce the effort required by the search infrastructure. The search infrastructure need only retrieve the preprocessing output and store same in its search databases and content storage. Depending on the content type, the preprocessing output may include one or more of: (i) indexing, e.g., (reverse) indexed data; (ii) digital signature data; (ii) content (e.g., image) characteristic data; (iii) translated (transcoded, resized, reformatted) versions of the original content; (iv) the original content; (v) meta data associated with the original content; (vi) security related data; (vii) user (& group) profile related information; (viii) user interaction data; (ix) popularity related information; (x) associated text (e.g., surrounding text for images, code, video, audio), etc. In addition, the technology described herein can also decrease overall traffic flow due to, for example, resizing and possibly never having to deliver actual content (larger data size) to a search infrastructure for processing.

In one embodiment, a client need not host to implement the technology described herein. Such preprocessing can be performed even if the client will never host. Such is the case where, along with the preprocessing indexes and other search database data, a copy of the content (possibly in native or one or more other preprocessed formats) is uploaded to any server including to a search infrastructure server.

In one embodiment, the web hosting servers do the preprocessing work for their own hosted content. This embodiment need not involve client hosting. That is, with current search infrastructure, if all web servers performed the preprocessing work, the crawling function could gather the same and the search data centers would not have to perform as much work and substantial bandwidth would be saved in not having to deliver actual content. In one embodiment, the prep results are captured by the search infrastructure during a crawl or are pushed by the search infrastructure for storage. In one example embodiment, tags similar to “No Follow” tags are added that will identify for any web page, one or more prep-output files that can be received by the search data center for review and integration into the search infrastructure. The prep-work includes one or more of the above described preprocessing items.

In one embodiment, a local server farm of web servers 210 application examines server farm hosted content, or in an example embodiment, program code associated with page server code. If the latter, the prep-output takes into account many variations in web page service and excludes private information and other no-follow information in a more granular way. Also, not all servers need to participate in the preprocessing functions. If not participating, a traditional crawl then preprocessing by the infrastructure is performed.

Search infrastructure applies several approaches to identify adequacy of hosting client/server preprocessing including, but not limited to:

1) spot check (search infrastructure uploads, perform preprocessing and compare with that uploaded);

2) popular sites which change frequently are continuously or more frequently checked;

3) time stamps and cached data are compared to prep-work output time stamps;

4) secure lock-down of client side/hosting server side code which performs the prep-work;

5) historical confidence levels based on past performance;

6) allow searcher (and server admin) feedback regarding mismatches; and

7) provide a preprocessed digital signature extracted from the content which is computed independently by a browser such that a comparison of prior preprocessed digital signature with the browser's signature to verify a content match.

FIG. 4 illustrates a client device flow diagram showing one embodiment in accordance with the present disclosure. Referring to FIG. 4, once client device hosted content is created and stored in memory of the client device, the client device follows various steps in order make the client device hosted content available to search requestors (211). In step 400, the client device provides client device identification (ID) and, optionally, type (e.g., smartphone, tablet, specific OS, device parameters) to the client device crawler 213. In step 401, a global network route to the identified client device content is determined in order to provide a pointer for the search engine to provide to a search requestor to access both the client device as well as specified content. In step 402, client device access restrictions are also provided, for example, access restrictions (login ID, password, public or private security keys, etc.). Client device information obtained in steps 400-402, in one embodiment, is provided to a client device registry 218, for example a registry maintained in a cloud based service which is accessible by the search system infrastructure.

In step 403, client device hosted content is preprocessed at the client so to provide, for example, a preview of images available by providing thumbnails of the images, small excerpts of text or a video preview. In optional step 404, the client device enters into a client device services agreement. With a client device services agreement, the client device will provide a copy to a third party storage system (remote servers/cloud based servers) of client device hosted client content for the purposes of providing a higher probability that their client device hosted content will be available, for the purposes of providing large scale access, as a backup or for the purposes of collecting royalties (payment). In step 405, access to specified client device hosted content (at the client or third party server) is provided to the search infrastructure. In one example embodiment, while the preprocessing is performed within the client device, the content is not hosted, but rather stored within web servers 210 or directly within the search infrastructure.

In one embodiment of a search infrastructure, including one or more content hosting elements, a user's content hosting and associated prep-output processing occurs only once. As such, search and service infrastructures utilize common (standardized) preprocessing approaches 406. For example, if the client device performs one prep-output processing pass and delivers same to each of a plurality of independent infrastructures, searches and use are carried out on each infrastructure while the actual client content is stored locally. For caching of the content toward the cloud, in one example embodiment, each infrastructure clones and moves forward to meet demand, user payment support, etc. In one example embodiment, preprocessing is cloud-to-cloud. For example, a Tweet or file upload via one service involves a decision on hosting and prep-output forwarding to all services.

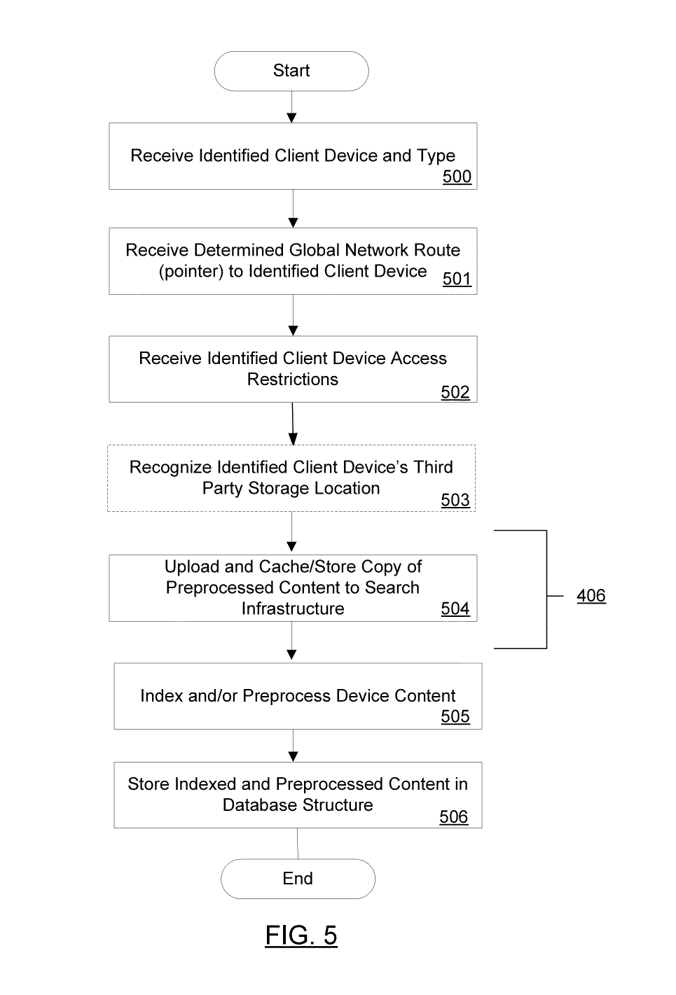

FIG. 5 illustrates a client device flow diagram showing another embodiment in accordance with the present disclosure. Referring to FIG. 5, once client device hosted content is created, the search infrastructure follows various steps in order make the client device hosted content available to search requestors (211). In step 500, the system obtains client device identification (ID) and, optionally, type (e.g., smartphone, tablet, specific OS, device parameters). In step 501, a global network route to the identified client device content is determined in order to provide a pointer for the search engine to provide to a search requestor to access both the client device as well as specified content. In step 502, client device access restrictions are acquired, for example, access restrictions (login ID, password, public or private security keys, etc.). Client device information obtained in steps 500-502, in one embodiment, is obtained (received from) a client device registry 218, for example a registry maintained in a cloud based service. In optional step 503, the search infrastructure recognizes (e.g., by receiving a modified or second pointer from the client device) a preferred location for accessing the client device content (not client hosted). In step 504, access to client preprocessed content is obtained and at least a portion is uploaded or cached in the search infrastructure. As described here before, search and service infrastructures utilize common (standardized) preprocessing approaches 406. In step 505, the preprocessed client device content (hosted or not hosted) is indexed. In step 506, the preprocessed and indexed client device content is stored in the search database structure 207 for access by the search engine.

FIG. 6 illustrates a search infrastructure flow diagram showing one embodiment in accordance with the present disclosure. Referring to FIG. 6, once client device content is created, the search infrastructure follows various steps in order make the content available to search requestors (211). In step 600, the system obtains client device identification (ID) and, optionally, type (e.g., smartphone, tablet, specific OS, device parameters). In step 601, a global network route to the identified client device content is determined in order to provide a pointer for the search engine to provide to a search requestor to access both the client device as well as specified content. In step 602, client device access restrictions are acquired, for example, access restrictions (login ID, password, public or private security keys, etc.). Client device information obtained in steps 600-602, in one embodiment, is obtained (received from) a client device registry 218, for example a registry maintained in a cloud based service (as previously described). In optional step 603, the search infrastructure recognizes a preferred client content storage location (remotely within the search infrastructure or remotely in third party storage) for accessing the client device content (modified or new link is communicated to search system infrastructure by client device). In step 604, access to content is obtained and at least a portion is uploaded or cached in the search infrastructure. In step 605, the client device hosted content is indexed and preprocessed within the search infrastructure. As described here before, search and service infrastructures utilize common (standardized) preprocessing approaches 406. In step 606, the indexed and preprocessed client device content is stored in the search database structure for access by the search engine.

FIG. 7 illustrates a search infrastructure diagram showing one embodiment in accordance with the present disclosure. As shown, FIG. 7 is one embodiment of the search infrastructure previously illustrated and described for FIG. 3. A client side helping device (preprocessing device module 701 with preprocessing module 702) is provided to support preprocessing outside of the client device (on its behalf). For example, a set-top box (STB), gateway device or access point (AP) performs preprocessing in whole or in part for one or more client devices. Preprocessed output, in one embodiment, is forwarded to the search infrastructure or to a remote server (e.g., third party storage or web server 210). Such a helping device might also participate by hosting the content in native and/or preprocessed formats.

In an embodiment of the technology described herein, separate fees can be charged for (i) storage of indexing information, (ii) storage of hosting content, (iii) storage of caching content, (iv) delivery of search results identifying same, (v) click through and pathway setup, (vi) cache delivery, (vii) full web hosting service, (viii) user/web-server device status management, (ix) pre-processing duties, etc.

In an embodiment of the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other known or future wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other known or future mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the mobile communication device.

Throughout the specification, drawings and claims various terminology is used to describe the one or more embodiments. As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the terms “prep-output processing”, “prepped” “preprocessing” and “pre-processing” are considered equivalent. In addition, the terms “client” and “client device” are also considered equivalent.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an example thereof, a feature thereof, a concept thereof, and/or an example thereof. A physical embodiment of an apparatus, an article of manufacture, a machine, and/or of a process that embodies the technology described herein may include one or more of the examples, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the technology as described herein have been expressly described herein, other combinations of these features and functions are likewise possible. The technology as described herein is not limited by the particular examples disclosed herein and expressly incorporates these other combinations.

1. A method performed by a client device, the method comprising:
preprocessing one or more portions of content hosted by the client device to produce preprocessed data;
communicating to a search system infrastructure the preprocessed data;
receiving a request from the search system infrastructure to access the one or more portions of content hosted by the client device; and
supporting access to the one or more portions of content by the search system infrastructure.

2. The method of claim 1, wherein the preprocessed one or more portions of content hosted by the client device is uploaded to the search infrastructure after preprocessing in one or more preprocessed formats.

3. The method of claim 2, wherein the preprocessing step comprises reducing data size of the content to decrease overall search infrastructure system traffic.

4. The method of claim 1, wherein the step of preprocessing further comprises the client device requesting at least part of the preprocessing from a remote device.

5. The method of claim 4, wherein the remote device comprises one or more of: a search system infrastructure processing module, a set-top box (STB), gateway device, access point (AP) and another client device.

6. The method of claim 1, wherein the preprocessing step comprises one or more of: indexing; reverse indexing; creating digital signatures; creating content characteristics; translating, transcoding, resizing, reformatting versions; creating meta data; creating security related data; creating user profile related information; creating group profile related information; creating user interaction data; creating popularity related information; and creating associated client device content text.

7. The method of claim 1, further comprising securing a remote storage location for storing a copy of the one or more portions of the content hosted by the client device and communicating the secured remote storage location to the search system infrastructure.

8. The method of claim 7, wherein the step of securing a remote storage space includes one or more of: continuous access to the search system infrastructure of the content hosted by the client device, large scale access to the content, backup of the content hosted by the client device, and a vehicle for collecting royalties or payments for accessed content.

9. A system supporting searching comprising:
a preprocessor preprocessing one or more portions of content hosted by a client device to produce preprocessed data;
a search system infrastructure receiving the preprocessed data, the search system infrastructure servicing a search request and producing a search result including at least one instance of the preprocessed data; and
wherein the search infrastructure supports access to the one or more portions of content hosted by a client device represented in the search result.

10. The system of claim 9, further comprising a preprocessor preprocessing one or more portions of content hosted by web servers.

11. The system of claim 10, further comprising a preprocessing coordination module to coordinate preprocessing of one or more of: the one or more portions of content hosted by the client devices and the one or more portions of content hosted by web servers.

12. The system of claim 11, wherein the preprocessing coordination module coordinates preprocessing according to processing loads of one or more of: the client devices and the web servers.

13. The system of claim 9, wherein the preprocessor comprises a plurality of modules including at least one crawler downloader module to preprocess the one or more portions of content hosted by a client device.

14. A system supporting searching comprising:
a search infrastructure;
the search infrastructure comprising a crawler including a plurality of modules to retrieve preprocessed data from a plurality of content hosting systems;
a search service searching the retrieved preprocessed data according to a received searching device request to produce a search result; and
wherein the search service supports a communication pathway between the searching device and the content hosting systems hosting one or more portions of the search results.

15. The system of claim 14, wherein the plurality of content hosting systems comprise at least client devices hosting searchable content.

16. The system of claim 14, wherein the plurality of content hosting systems comprise at least client devices hosting searchable content and web servers hosting searchable web content.

17. The system of claim 16, further comprising a preprocessing coordination module to coordinate preprocessing of one or more of: content hosted by the client devices hosting searchable content and the web servers hosting searchable web content.

18. The system of claim 16, wherein the plurality of modules comprise at least one web crawler downloader module to preprocess one or more portions of the content hosted by the web servers hosting searchable web content.

19. The system of claim 14, wherein the search service further comprises one or more search engines to provide the search results, including at least one instance of the content hosted by the client devices, to the searching device.

20. The system of claim 14, wherein the plurality of modules comprise at least one crawler downloader module to preprocess one or more portions of the content hosted by the client devices hosting searchable content.
